(19) United States
(12) Patent Application Publication
(10) Pub. No.: US 2025/0076137 A1
(43) Pub. Date: Mar. 6, 2025

(54) ANTI-FORCE BRAKE TESTING PLATFORM AND METHOD FOR ELECTRIC VEHICLE BASED ON MODEL PREDICTIVE CONTROL (MPC)

(71) Applicant: CHANG'AN UNIVERSITY, Xi'an (CN)

(72) Inventors: Xuan ZHAO, Xi'an (CN); Kai ZHANG, Xi'an (CN); Xiaolei YUAN, Xi'an (CN); Shu WANG, Xi'an (CN); Jian MA, Xi'an (CN); Yisong CHEN, Xi'an (CN); Dean MENG, Xi'an (CN); Rui LIU, Xi'an (CN); Yilin HE, Xi'an (CN); Qifan XUE, Xi'an (CN)

(21) Appl. No.: 18/954,386

(22) Filed: Nov. 20, 2024

(30) Foreign Application Priority Data
Nov. 28, 2023 (CN) 202311603900.0

(51) Int. Cl. G01L 5/28

(52) U.S. Cl. CPC G01L 5/282

(57) ABSTRACT

An anti-force brake testing platform for an electric vehicle based on model predictive control (MPC) includes a first testing unit; a second testing unit; a third testing unit; a fourth testing unit; a wheelbase adjustment device; and a control cabinet system. The first and second testing units are structurally identical and have the same height, and are provided at the same horizontal foundation plane, with each including a first driving device, a first roller group, a first lifting device, a steering device, a frame, and a first control and test device. The third and fourth testing units are structurally identical, with each including a second driving device, a second roller group, a second lifting device, an anti-slip stopping mechanism, a first fixed base frame, a locking mechanism, and a second control and test device. The wheelbase adjustment device includes a second fixed base frame and a movable stand.

### CROSS-REFERENCE TO RELATED APPLICATIONS

This application claims the benefit of priority from Chinese Patent Application No. 202311603900.0, filed on Nov. 28, 2023. The content of the aforementioned application, including any intervening amendments made thereto, is incorporated herein by reference in its entirety.

### TECHNICAL FIELD

This application relates to brake testing of electric vehicles, and more particularly to an anti-force brake testing platform and method for an electric vehicle based on MPC.

### BACKGROUND

Braking performance is closely associated with the driving safety. Road test can only reflect the overall braking performance of the vehicle, and fails to identify the differences in braking performance among individual wheels. For vehicles with an inadequate braking performance, it fails to identify the specific location of the fault. In contrast, the bench testing method has high efficiency, excellent cost-effectiveness, and reliable safety, and is not susceptible to external conditions, and thus has been widely used in the brake performance testing of vehicles.

Regarding the bench testing, the braking force is measured by a brake testing platform to evaluate the service brake performance and parking brake performance of traditional internal combustion engine (ICE) vehicles. The brake testing platform mainly includes a measurement device, a roller device, and a control and display device. Considering the unique characteristics of the braking process of electric vehicles, it is necessary to test the recovery of braking energy. Therefore, it is required to modify the traditional brake testing platform for ICE vehicles to meet the testing requirements of electric vehicles.

The traditional bench testing method generally adopts an anti-force roller brake testing platform to test the brake performance of ICE vehicles. However, the wheel rotation speed may be inconsistent with the roller rotation speed, which will cause shaking or even detachment from the testing platform during the testing process. Additionally, electric vehicles are usually free of a rear tow hook, making it difficult to firmly and stably secure them during the bench testing and maintain the stability.

### SUMMARY

In view of the problems in the prior art, this application provides an anti-force brake testing platform and method for an electric vehicle based on MPC, which can accurately estimate the braking energy regeneration during the braking process of electric vehicles, and also effectively prevent the to-be-tested electric vehicle from detaching from the test bench during the testing process.

To achieve the above objectives, the present disclosure provides the following technical solutions.

An anti-force brake testing platform for an electric vehicle based on MPC, comprising
a first testing unit;
a second testing unit;
a third testing unit;
a fourth testing unit;
a wheelbase adjustment device; and
a control cabinet system;
wherein the first testing unit is configured to test a braking force of a first front wheel of the electric vehicle; the second testing unit is configured to test a braking force of a second front wheel of the electric vehicle; the third testing unit is configured to test a braking force of a first rear wheel of the electric vehicle; and the fourth testing unit is configured to test a braking force of a second rear wheel of the electric vehicle;
the first testing unit and the second testing unit are structurally identical and have the same height, and are provided at the same horizontal foundation plane; and each of the first testing unit and the second testing unit comprises a first driving device, a first roller group, a first lifting device, a steering device, a frame and a first control and test device;
the third testing unit and the fourth testing unit are structurally identical; each of the third testing unit and the fourth testing unit comprises a second driving device, a second roller group, a second lifting device, an anti-slip stopping mechanism, a first fixed base frame, a locking mechanism and a second control and test device; the wheelbase adjustment device comprises a second fixed base frame and a first movable stand provided on the second fixed base frame; and the third testing unit and the fourth testing unit are provided on the second fixed base frame;
the first driving device is configured to provide a first driving force, and the second driving device is configured to provide a second driving force; the first roller group is configured to transmit the first driving force to a corresponding front wheel; the second roller group is configured to transmit the second driving force to a corresponding rear wheel; the first lifting device is configured to adjust a height of the first roller group; the second lifting device is configured to adjust a height of the second roller group; and the first control and test device and the second control and test device are connected to the control cabinet system;
the locking mechanism is configured to lock the second roller group; the anti-slip stopping mechanism is configured to stop and limit a corresponding rear wheel from an outside of the second roller group; and
a centerline of the first roller group of the first testing unit coincides with a centerline of the first roller group of the second testing unit; a centerline of the second roller group of the third testing unit coincides with a centerline of the second roller group of the fourth testing unit; a centerline between the first testing unit and the second testing unit coincides with a centerline between the third testing unit and the fourth testing unit; and a centerline of the wheelbase adjustment device and the centerline between the third testing unit and the fourth testing unit are located on the same plane.

In an embodiment, the first driving device comprises a driving motor, a decelerator and a transmission system; the first roller group comprises a driving roller and a driven roller; the driving motor is configured to output a power to the decelerator; the transmission system is configured to transmit the power from the decelerator to the driving roller; the driving roller is configured to transmit the power to the driven roller through a synchronous belt, so as to maintain consistent motion between the driving roller and the driven roller; and the driving motor is fixed to the first fixed base frame;
a first end of the driving roller is configured to be supported on the frame through a first rolling bearing and a first bearing seat; a second end of the driving roller is configured to be supported on the frame through a second rolling bearing and a second bearing seat; a first end of the driven roller is configured to be supported on the frame through a third rolling bearing and a third bearing seat; a second end of the driven roller is configured to be supported on the frame through a fourth rolling bearing and a fourth bearing seat; and an axis of the driving roller is parallel to an axis of the driven roller;
the driving roller is provided with a first shaft, and the first shaft is provided on the first bearing seat and the second bearing seat through the first rolling bearing and the second rolling bearing; the first shaft is configured to align with a center of the first rolling bearing and a center of the second rolling bearing; a surface side of each of the first rolling bearing and the second rolling bearing is parallel to an end face of the first shaft; the first rolling bearing and the second rolling bearing are symmetrically arranged; two sides of the driving roller are each provided with a second shaft; the second shaft at one side of the driving roller is connected to a transmission gear of the transmission system through a first pin key; and the second shaft at the other side of the driving roller is connected to the synchronous belt via a second pin key; and
the driven roller is provided with a third shaft, and the third shaft is provided on the third bearing seat and the fourth bearing seat through the third rolling bearing and the fourth rolling bearing; the third shaft is configured to align with a center of the third rolling bearing and a center of the fourth rolling bearing; a side surface of each of the third rolling bearing and the fourth rolling bearing is parallel to an end face of the third shaft; the third rolling bearing and the fourth rolling bearing are symmetrically arranged; two sides of the driven roller are each provided with a fourth shaft; the fourth shaft at one side of the driven roller is configured to be vacant; the fourth shaft at the other side of the driven roller is connected to the synchronous belt via a third pin key.

In an embodiment, the first lifting device comprises a lifting block and an air pump; a transverse centerline of the first lifting device is provided at a center between the driving roller and the driven roller; a front surface of the lifting block is parallel to a vertical section of the driving roller; a rear surface of the lifting block is parallel to a vertical section of the driven roller; a lower end of the lifting block is connected to the air pump via three linkage mechanisms, thereby transmitting a force from the air pump to the lifting block; the air pump is fixed to an air pump support frame; the air pump support frame is secured to the frame through four bolts; and the four bolts are symmetrically arranged.

In an embodiment, the steering device comprises a first steering gear, a second steering gear, and a steering servo motor; the first steering gear is larger than the second steering gear; the frame is provided above the first steering gear and the second steering gear; the first steering gear is engaged with the second steering gear on the same plane; and the first steering gear is connected to a transmission shaft and the steering servo motor via a fourth pin key;
the anti-force brake testing platform further comprises a track width adjustment device; the track width adjustment device comprises a second movable stand; the frame, the first steering gear and the second steering gear are provided on the second movable stand; the track width adjustment device further comprises two first adjustment rails and two second adjustment rails; and the two first adjustment rails are perpendicular to the two second adjustment rails;
each of the two first adjustment rails comprises two first rail assemblies; the two first rail assemblies are structurally identical, and are symmetrically arranged; each of the two first adjustment rails is covered by a first compressible dust-proof cover; and an end of each of the two first adjustment rails is provided with a first baffle; and
each of the two second adjustment rails comprises two second rail assemblies; the two second rail assemblies are structurally identical, and are symmetrically arranged; each of the two second adjustment rails is covered by a second compressible dust-proof cover; and an end of each of the second adjustment rails is provided with a second baffle.

In an embodiment, the second driving device comprises a driving motor, a decelerator and a transmission system; the second roller group comprises a driving roller and a driven roller; the driving motor is configured to output a power to the decelerator; the transmission system is configured to transmit the power from the decelerator to the driving roller; the driving roller is configured to transmit the power to the driven roller through a synchronous belt, so as to maintain consistent motion between the driving roller and the driven roller; and the driving motor is fixed to a middle subframe of the first movable stand;
the driving roller and the driven roller are structurally identical; a first end of the driving roller is configured to be supported on the first fixed base frame through a first rolling bearing and a first bearing seat; a second end of the driving roller is configured to be supported on the first fixed base frame through a second rolling bearing and a second bearing seat; a first end of the driven roller is configured to be supported on the first fixed base frame through a third rolling bearing and a third bearing seat; a second end of the driven roller is configured to be supported on the first fixed base frame through a fourth rolling bearing and a fourth bearing seat; and an axis of the driving roller is parallel to an axis of the driven roller;
the driving roller is provided with a first shaft, and the first shaft is provided on the first bearing seat and the second bearing seat through the first rolling bearing and the second rolling bearing; the first shaft is configured to align with a center of the first rolling bearing and a center of the second rolling bearing; a side surface of each of the first rolling bearing and the second rolling bearing is parallel to an end face of the first shaft; the first rolling bearing and the second rolling bearing are symmetrically arranged; two sides of the driving roller are each provided with a second shaft; the second shaft at one side of the driving roller is connected to a transmission gear of the transmission system through a first pin key, and the second shaft at the other side of the driving roller is connected to the synchronous belt via a second pin key; and
the driven roller is provided with a third shaft, and the third shaft is provided on the third bearing seat and the fourth bearing seat through the third rolling bearing and the fourth rolling bearing; the third shaft is configured to align with a center of the third rolling bearing and a center of the fourth rolling bearing; a side surface of each of the third rolling bearing and the fourth rolling bearing is parallel to an end face of the third shaft; the third rolling bearing and the fourth rolling bearing are symmetrically arranged; two sides of the driven roller are each provided with a fourth shaft; the fourth shaft at one side of the driven roller is configured to be vacant, and the fourth shaft at the other side of the driven roller is connected to the synchronous belt via a third pin key.

In an embodiment, the second lifting device comprises a lifting block and an air pump; a transverse centerline of the second lifting device is provided at a center between the driving roller and the driven roller; a front surface of the lifting block is parallel to a vertical section of the driving roller; a rear surface of the lifting block is parallel to a vertical section of the driven roller; a lower end of the lifting block is connected to the air pump via a first linkage, thereby transmitting a force from the air pump to the lifting block; the air pump is fixed to an air pump support frame; the air pump support frame is secured to the first movable stand through four first bolts; and the four first bolts are symmetrically arranged.

In an embodiment, the number of the locking mechanism is two; two locking mechanisms are connected to the lifting block through a second linkage and a second bolt;
the two locking mechanisms are symmetrically arranged with respect to the air pump; the two locking mechanisms are configured to rise to lock the second roller group in response to a case that the lifting block is driven by the air pump to rise; and
the number of the anti-slip stopping mechanism is two; one of two anti-slip stopping mechanisms is located on an outer side of the driving roller, and the other of the two anti-slip stopping mechanisms is located on an outer side of the driven roller; each of the two anti-slip stopping mechanisms comprises a solid cylindrical roller, two fifth bearings, two fifth bearing seats, and two spring seats; the two fifth bearing seats are symmetrically arranged on both sides of the solid cylindrical roller; centers of the two fifth bearings coincide with a center of the solid cylindrical roller; the two fifth bearing seats are boltedly fixed to the two spring seats, respectively; and the two anti-slip stopping mechanisms of the third testing unit are structurally identical to the two anti-slip stopping mechanisms of the fourth testing unit.

In an embodiment, the wheelbase adjustment device further comprises a wheelbase adjustment motor, an intermediate shaft, a coupling, two dust-proof covers, a threaded rod, two supports for supporting the first movable stand, and a wheelbase adjustment rail assembly; the wheelbase adjustment rail assembly comprises two baffle plates, two fasteners and a sliding rail; the two fasteners are configured to be respectively fastened to two sides of the sliding rail; the wheelbase adjustment motor is configured to drive the first movable stand on which the first testing unit and the second testing unit are provided to move along the sliding rail; and the two baffle plates are respectively fixed at both ends of the sliding rail for limiting; and
top surfaces of the two supports are fixedly connected to the first movable stand; bottom surfaces of the two supports are fixedly connected to the two fasteners, respectively; the threaded rod is configured to pass through an assembly formed by the two fasteners and the two supports; each of the two dust-proof covers is annularly distributed along the threaded rod; the coupling is fixed to an end of the threaded rod via a first screw; the intermediate shaft is fixed to an end of the coupling via four second screws; and the wheelbase adjustment motor is fixed to an end of the intermediate shaft via a third screw.

In an embodiment, the anti-force brake testing platform further comprises a MPC system; each of the first front wheel and the second front wheel is provided with a speed sensor to collect a wheel rotation speed; and the MPC system is configured to correct a rotation speed of the driving motor to be the same as the wheel rotation speed, so as to achieve synchronized rotation.

A testing method using the anti-force brake testing platform, comprising:
inputting parameters of the electric vehicle to the control cabinet system wherein the parameters comprise a wheelbase of the electric vehicle; adjusting, by the wheelbase adjustment device, a wheelbase of the anti-force brake testing platform based on the wheelbase of the electric vehicle; locking, by the locking mechanism, the second roller group; lowering the anti-slip stopping mechanism and driving the electric vehicle to the anti-force brake testing platform, after sensing that the electric vehicle reaches the anti-force brake testing platform, sending, by a sensor, a signal to make the locking mechanism disengaged from the second roller group to allow the first rear wheel and the second rear wheel to be respectively suspended between a driving roller and a driven roller of the second roller group;
according to required testing conditions, controlling an output speed and an output torque of a driving motor of each of the first driving device and the second driving device; performing, by a decelerator of each of the first driving device and the second driving device, speed reduction and torque increase; driving, by a first transmission mechanism, a driving roller of the first roller group to rotate, so as to drive a driven roller of the first roller group to rotate synchronously through a first synchronous mechanism; driving, by a second transmission mechanism, the driving roller of the second roller group to rotate, so as to drive the driven roller of the second roller group to rotate synchronously through a second synchronous mechanism; driving, by the driven roller of the first roller group, the first front wheel and the second front wheel to rotate; and driving, by the driven roller of the second roller group, the first rear wheel and the second rear wheel to rotate; pressing a brake pedal, and measuring, by a force sensor, a braking force of each of the first front wheel, the second front wheel, the first rear wheel and the second rear wheel; determining a braking force distribution between a front axle and a rear axle of the electric vehicle and a braking synchronization between the front axle and the rear axle to reflect stability of the electric vehicle during a braking process; and reading information from a battery management system (BMS) of the electric vehicle to calculate a regenerative braking energy of the electric vehicle; and
after test, locking, by the locking mechanism, the second roller group; and transferring the electric vehicle form anti-force brake testing platform.

Compared to the prior art, the solution provided in the present disclosure has the advantages as follows.

This brake testing platform provided in the present disclosure is upgraded based on the brake testing platform for the traditional ICE vehicle. Firstly, by using specialized testing equipment for power batteries to read information from the BMS of the electric vehicle, the regenerative braking energy during the electric vehicle's braking process can be accurately calculated and estimated. Secondly, by measuring the braking force distribution between the front and rear axles and the braking synchronization of the front and rear axles, the driving stability of the vehicle during the braking process can be reflected. Therefore, the brake testing platform of this present disclosure can test the braking force of each wheel, specifically measuring the braking force distribution between the front and rear axles and the braking synchronization, thus reflecting the vehicle's driving stability during braking. The brake testing platform of this present disclosure also allows for adjustments to the wheelbase between the front and rear axles and the track width between the left and right wheels, enabling the testing of various vehicle models, with a wide range of applications and strong adaptability. Additionally, this present disclosure includes an anti-slip stopping mechanism, enhancing the safety of the experiments. Moreover, the testing method using the anti-force brake testing platform provided in this present disclosure, based on the MPC strategy, can effectively avoid the uncontrollable detachment of the electric vehicles from the test dynamometer during testing.

### BRIEF DESCRIPTION OF THE DRAWINGS

FIG. 1 is a structural diagram of the anti-force brake testing platform according to an embodiment of the present disclosure;

FIG. 2 is a structural diagram of the front wheel braking force testing unit of the anti-force brake testing platform according to an embodiment of the present disclosure;

FIG. 3 is a structural diagram of the rear wheel braking force testing unit of the anti-force brake testing platform according to an embodiment of the present disclosure;

FIG. 4 is a structural diagram of the driving device of the front wheel braking force testing unit of the anti-force brake testing platform according to an embodiment of the present disclosure;

FIG. 5 is a structural diagram of the roller group of the front wheel braking force testing unit of the anti-force brake testing platform according to an embodiment of the present disclosure;

FIG. 6 is a structural diagram of the lifting device of the front wheel braking force testing unit of the anti-force brake testing platform according to an embodiment of the present disclosure;

FIG. 7 is a structural diagram of the steering device of the front wheel braking force testing unit of the anti-force brake testing platform according to an embodiment of the present disclosure;

FIG. 8 is a structural diagram of the track width adjustment device according to an embodiment of the present disclosure;

FIG. 9 is a structural diagram of the driving device of the rear wheel braking force testing unit of the anti-force brake testing platform according to an embodiment of the present disclosure;

FIG. 10 is a structural diagram of the roller group of the rear wheel braking force testing unit of the anti-force brake testing platform according to an embodiment of the present disclosure;

FIG. 11 is a structural diagram of the lifting device and locking mechanism of the rear wheel braking force testing unit of the anti-force brake testing platform according to an embodiment of the present disclosure;

FIG. 12 is a structural diagram of the wheelbase adjustment device of the rear wheel braking force testing unit of the anti-force brake testing platform according to an embodiment of the present disclosure;

FIG. 13 is a structural diagram of the anti-slip stopping mechanism according to an embodiment of the present disclosure;

FIG. 14 is a block diagram of the overall simulation model according to an embodiment of the present disclosure;

FIG. 15 is a block diagram of the cross-coupling control according to an embodiment of the present disclosure;

FIG. 16 illustrates the simulation result of the rotational speed conditions according to an embodiment of the present disclosure; and

FIG. 17 illustrates the result of the rotational speed error according to an embodiment of the present disclosure.

### DETAILED DESCRIPTION OF EMBODIMENTS

The present disclosure will be further described in detail below in conjunction with the accompanying drawings.

The traditional bench testing method generally adopts an anti-force roller brake testing platform to test the brake performance of ICE vehicles. However, the wheel rotation speed may be inconsistent with the roller rotation speed, which will cause shaking or even detachment from the testing platform during the testing process. Additionally, electric vehicles are usually free of a rear tow hook, making it difficult to firmly and stably secure them during the bench testing and maintain the stability.

Based on this, the embodiment of the present disclosure modifies and upgrades the traditional brake testing platform to meet the needs of braking performance testing for electric vehicles. In addition to conventional braking test capabilities, the following requirements are proposed for the brake testing platform for the electric vehicle.

I) Due to the specially developed testing equipment for power batteries, the information BMS of the electric vehicle is read from the electric vehicle's battery system, enabling accurate calculation and estimation of the regenerative braking energy feedback during the braking process.

II) The brake testing platform can measure the braking force distribution between the front and rear axles and the braking synchronization between the front and rear axles, so the vehicle's stability during the braking process is reflected.

III) Due to a synchronization control strategy, the roller speed of the brake testing platform remains consistent with the speed of the vehicle wheel, thereby avoiding issues such as vibrations and detachment.

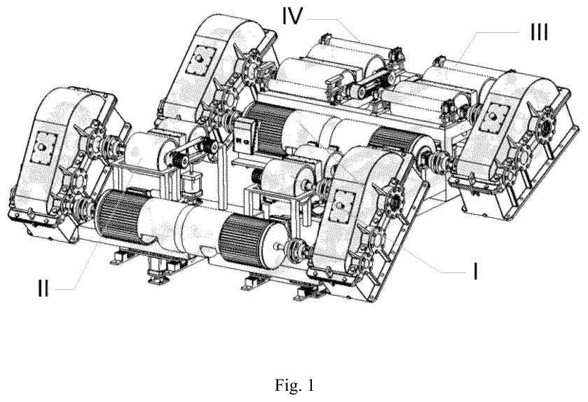

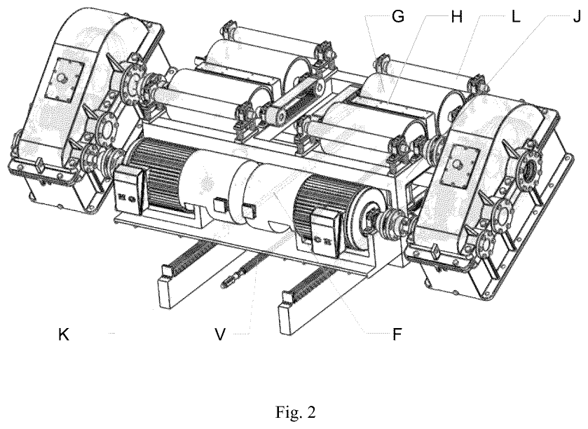

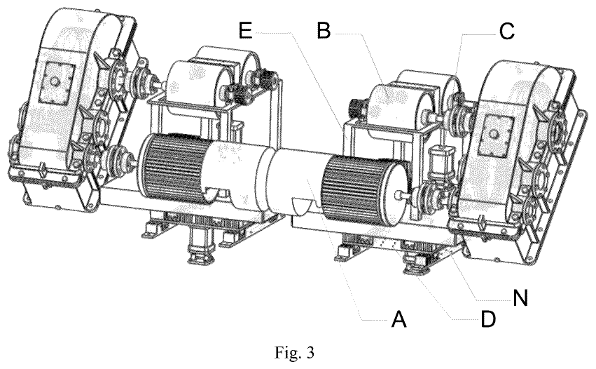

As shown in FIGS. 1-3, an anti-force brake testing platform for an electric vehicle based on MPC provided herein includes a left-front-wheel braking-force testing unit I, a right-front-wheel braking-force testing unit II, a left-rear-wheel braking-force testing unit III, a right-rear-wheel braking-force testing unit IV, a wheelbase adjustment device V and a control cabinet system. The left-front-wheel braking-force testing unit I and the right-front-wheel braking-force testing unit II are structurally identical and have the same height, and are provided at the same horizontal foundation plane; and each of the left-front-wheel braking-force testing unit I and the right-front-wheel braking-force testing unit II includes a first driving device A, a first roller group B, a first lifting device C, a steering device D, a frame E and a first control and test device. The left-rear-wheel braking-force testing unit III and the right-rear-wheel braking-force testing unit IV are structurally identical; each of the left-rear-wheel braking-force testing unit III and the right-rear-wheel braking-force testing unit IV includes a second driving device F, a second roller group G, a second lifting device H, an anti-slip stopping mechanism L, a locking mechanism M, a first fixed base frame J, and a second control and test device; the wheelbase adjustment device V includes a second fixed base frame and a first movable stand K provided on the second fixed base frame; and the left-rear-wheel braking-force testing unit III and the right-rear-wheel braking-force testing unit IV are provided on the second fixed base frame. A centerline of the first roller group of the left-front-wheel braking-force testing unit I coincides with a centerline of the first roller group of the right-front-wheel braking-force testing unit II; a centerline of the second roller group of the left-rear-wheel braking-force testing unit III coincides with a centerline of the second roller group of the right-rear-wheel braking-force testing unit IV; a centerline between the left-front-wheel braking-force testing unit I and the right-front-wheel braking-force testing unit II coincides with a centerline between the left-rear-wheel braking-force testing unit III and the right-rear-wheel braking-force testing unit IV; and a centerline of the wheelbase adjustment device and the centerline between the left-rear-wheel braking-force testing unit III and the right-rear-wheel braking-force testing unit IV are located on the same plane.

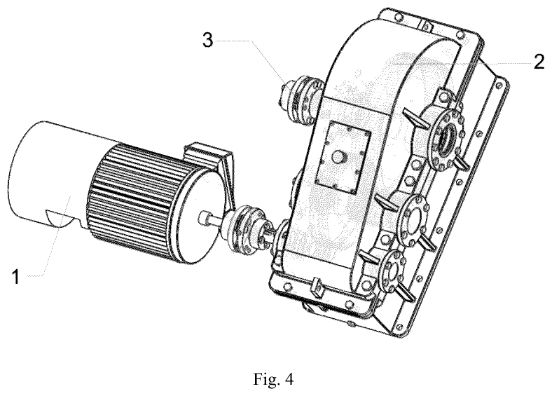

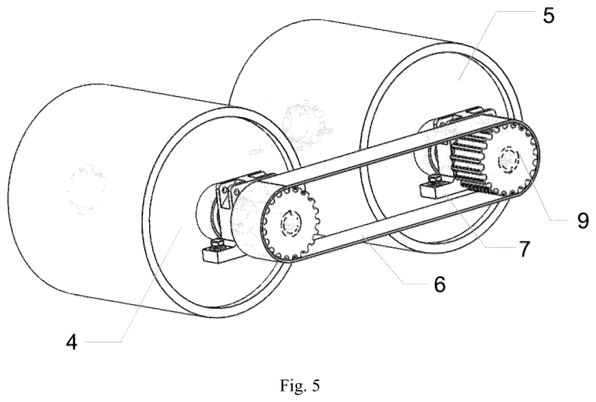

As shown in FIGS. 4 and 5, each of the left-front-wheel braking-force testing unit I and the right-front-wheel braking-force testing unit II includes a first driving device A, a first roller group B, a first lifting device C, a steering device D, a frame E and a first control and test device. The first driving device A includes a driving motor 1, a decelerator 2 and a transmission system 3; the first roller group B includes a driving roller 4 and a driven roller 5; the driving motor 1 is configured to output a power to the decelerator 2; the transmission system 3 is configured to transmit the power from the decelerator 2 to the driving roller 4; the driving roller 4 is configured to transmit the power to the driven roller 5 through a synchronous belt 6, so as to maintain consistent motion between the driving roller 4 and the driven roller 5; and the driving motor 1 is fixed to the first fixed base frame J.

In the first roller group B, the driving roller 4 and the driven roller 5 are the same in structure; a first end of the driving roller 4 is configured to be supported on the frame E through a first rolling bearing and a first bearing seat 7; a second end of the driving roller 4 is configured to be supported on the frame E through a second rolling bearing and a second bearing seat 7; a first end of the driven roller 5 is configured to be supported on the frame E through a third rolling bearing and a third bearing seat 7; a second end of the driven roller 5 is configured to be supported on the frame E through a fourth rolling bearing and a fourth bearing seat 7; and an axis of the driving roller 4 is parallel to an axis of the driven roller 5. The driving roller 4 is provided with a first shaft, and the first shaft is provided on the first bearing seat 7 and the second bearing seat 7 through the first rolling bearing and the second rolling bearing; the first shaft is configured to align with a center of the first rolling bearing and a center of the second rolling bearing; a surface side of each of the first rolling bearing and the second rolling bearing is parallel to an end face of the first shaft; the first rolling bearing and the second rolling bearing are symmetrically arranged; two sides of the driving roller 4 are each provided with a second shaft; the second shaft at one side of the driving roller 4 is connected to a transmission gear of the transmission system 3 through a first pin key; and the second shaft at the other side of the driving roller 4 is connected to the synchronous belt via a second pin key. The driven roller 5 is provided with a third shaft, and the third shaft is provided on the third bearing seat 7 and the fourth bearing seat 7 through the third rolling bearing and the fourth rolling bearing; the third shaft is configured to align with a center of the third rolling bearing and a center of the fourth rolling bearing; a side surface of each of the third rolling bearing and the fourth rolling bearing is parallel to an end face of the third shaft; the third rolling bearing and the fourth rolling bearing are symmetrically arranged; two sides of the driven roller 5 are each provided with a fourth shaft; the fourth shaft at one side of the driven roller 5 is configured to be vacant; the fourth shaft at the other side of the driven roller 5 is connected to the synchronous belt via a third pin key.

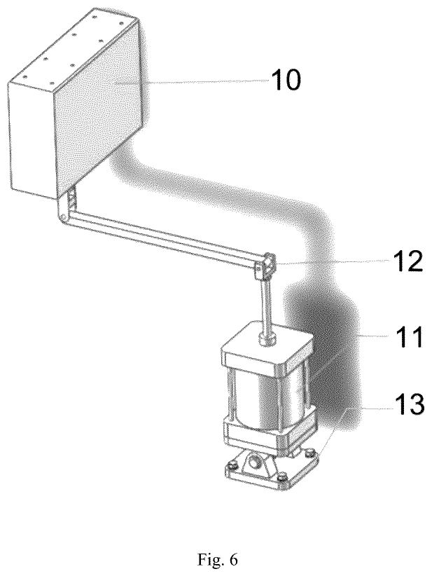

As shown in FIG. 6, the first lifting device C includes a lifting block 10 and an air pump 11; a transverse centerline of the first lifting device C is provided at a center between the driving roller 4 and the driven roller 5; a front surface of the lifting block 10 is parallel to a vertical section of the driving roller 4; a rear surface of the lifting block 10 is parallel to a vertical section of the driven roller 5; a lower end of the lifting block 10 is connected to the air pump 11 via three linkage mechanisms 12, thereby transmitting a force from the air pump 11 to the lifting block 10; the air pump 11 is fixed to an air pump support frame 13; the air pump support frame 13 is secured to the frame through four bolts; and the four bolts are symmetrically arranged.

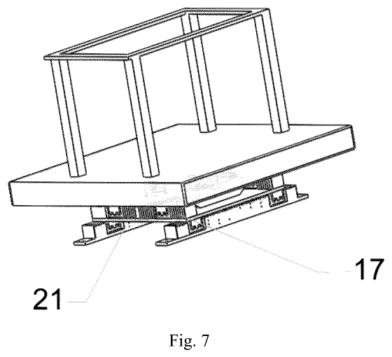

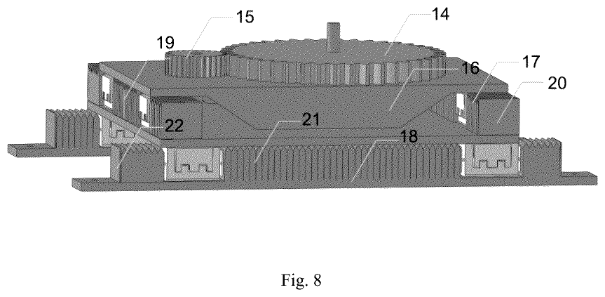

The steering device D includes a first steering gear 14, a second steering gear 15, and a steering servo motor 16; the first steering gear 14 is larger than the second steering gear 15; the frame E is provided above the first steering gear 14 and the second steering gear 15; the first steering gear 14 is engaged with the second steering gear 15 on the same plane; and the first steering gear 14 is connected to a transmission shaft and the steering servo motor 16 via a fourth pin key. The anti-force brake testing platform further includes a track width adjustment device N; the track width adjustment device N includes a second movable stand. The frame E, the first steering gear 14 and the second steering gear 15 are provided on the second movable stand. As shown in FIGS. 7 and 8, the track width adjustment device N further includes two first adjustment rails 17 and two second adjustment rails 18; and the two first adjustment rails 17 are perpendicular to the two second adjustment rails 18. Each of the two first adjustment rails 17 includes two first rail assemblies; the two first rail assemblies are structurally identical, and are symmetrically arranged; each of the two first adjustment rails 17 is covered by a first compressible dust-proof cover 19; and an end of each of the two first adjustment rails 17 is provided with a first baffle 20. Each of the two second adjustment rails 18 includes two second rail assemblies; the two second rail assemblies are structurally identical, and are symmetrically arranged; each of the two second adjustment rails 18 is covered by a second compressible dust-proof cover 21; and an end of each of the second adjustment rails 18 is provided with a second baffle 22.

The control and test devices are connected to the driving motor and the control cabinet system through a wiring harness. The control cabinet system controls the output torque and speed of the driving motor via the control and test devices.

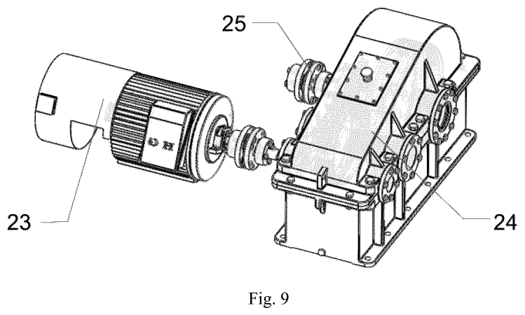

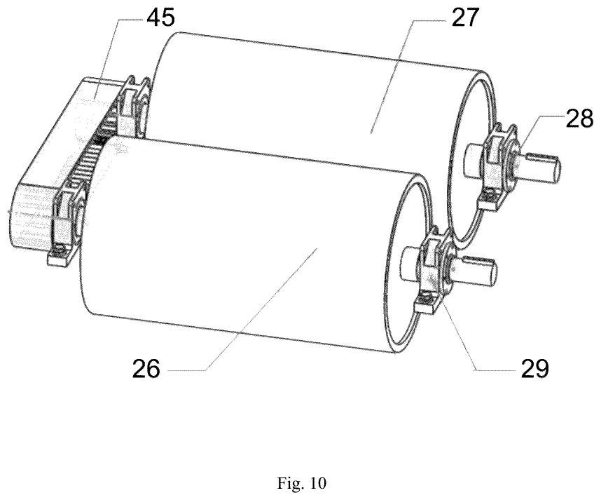

Each of the left-rear-wheel braking-force testing unit III and the right-rear-wheel braking-force testing unit IV includes a second driving device F, a second roller group G, a second lifting device H, an anti-slip stopping mechanism L, a locking mechanism M and a second control and test device. As shown in FIGS. 8-10, the second driving device F includes a driving motor 23, a decelerator 24 and a transmission system 25; the second roller group G includes a driving roller 26 and a driven roller 27; the driving motor 23 is configured to output a power to the decelerator 24; the transmission system 25 is configured to transmit the power from the decelerator 24 to the driving roller 26; the driving roller 26 is configured to transmit the power to the driven roller 27 through a synchronous belt, so as to maintain consistent motion between the driving roller 26 and the driven roller 27; and the driving motor 23 is fixed to a middle subframe of the first movable stand K.

In the second roller group G, the driving roller 26 and the driven roller 27 are structurally identical; a first end of the driving roller 26 is configured to be supported on the first fixed base frame J through a first rolling bearing 28 and a first bearing seat 29; a second end of the driving roller 26 is configured to be supported on the first fixed base frame J through a second rolling bearing 28 and a second bearing seat 29; a first end of the driven roller 27 is configured to be supported on the first fixed base frame J through a third rolling bearing 28 and a third bearing seat 29; a second end of the driven roller 27 is configured to be supported on the first fixed base frame J through a fourth rolling bearing 28 and a fourth bearing seat 29; and an axis of the driving roller 26 is parallel to an axis of the driven roller 27. The driving roller 26 is provided with a first shaft, and the first shaft is provided on the first bearing seat 29 and the second bearing seat 29 through the first rolling bearing 28 and the second rolling bearing 28; the first shaft is configured to align with a center of the first rolling bearing 28 and a center of the second rolling bearing 28; a side surface of each of the first rolling bearing 28 and the second rolling bearing 28 is parallel to an end face of the first shaft; the first rolling bearing 28 and the second rolling bearing 28 are symmetrically arranged; two sides of the driving roller 26 are each provided with a second shaft; the second shaft at one side of the driving roller 26 is connected to a transmission gear of the transmission system 25 through a first pin key, and the second shaft at the other side of the driving roller 26 is connected to the synchronous belt via a second pin key. The driven roller 27 is provided with a third shaft, and the third shaft is provided on the third bearing seat 29 and the fourth bearing seat 29 through the third rolling bearing 28 and the fourth rolling bearing 28; the third shaft is configured to align with a center of the third rolling bearing 28 and a center of the fourth rolling bearing 28; a side surface of each of the third rolling bearing 28 and the fourth rolling bearing 28 is parallel to an end face of the third shaft; the third rolling bearing 28 and the fourth rolling bearing 28 are symmetrically arranged; two sides of the driven roller 27 are each provided with a fourth shaft; the fourth shaft at one side of the driven roller 27 is configured to be vacant, and the fourth shaft at the other side of the driven roller 27 is connected to the synchronous belt via a third pin key.

The second lifting device H includes a lifting block 30 and an air pump 31; a transverse centerline of the second lifting device H is provided at a center between the driving roller 26 and the driven roller 27; a front surface of the lifting block 30 is parallel to a vertical section of the driving roller 26; a rear surface of the lifting block 30 is parallel to a vertical section of the driven roller 27; a lower end of the lifting block 30 is connected to the air pump 31 via a first linkage, thereby transmitting a force from the air pump 31 to the lifting block 30; the air pump 31 is fixed to an air pump support frame 32; the air pump support frame 32 is secured to the first fixed base frame J through four first bolts; and the four first bolts are symmetrically arranged. Furthermore, the longitudinal center plane of the air pump 31 coincides with the longitudinal center plane of the lifting block 30.

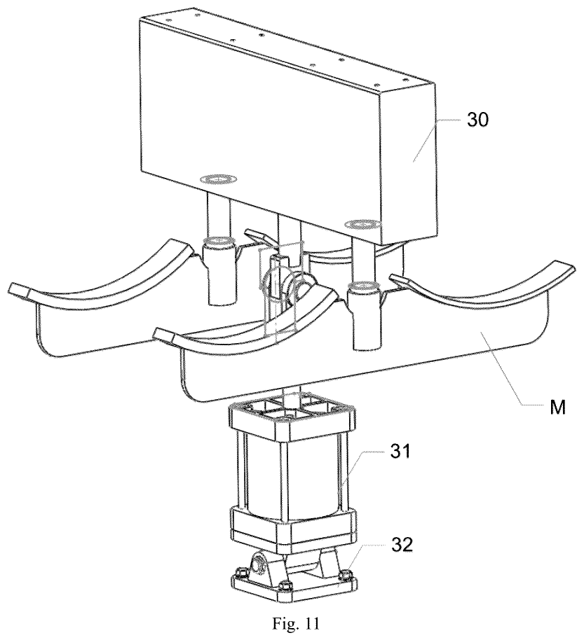

As shown in FIG. 11, the locking mechanism M is connected to the lifting block 30 through a connecting rod and bolts. The number of the locking mechanisms M is two. The two locking mechanisms M are symmetrically arranged relative to the air pump 31. When the air pump 31 drives the lifting block 30 to rise, the locking mechanism M rises with it, locking the roller groups in place.

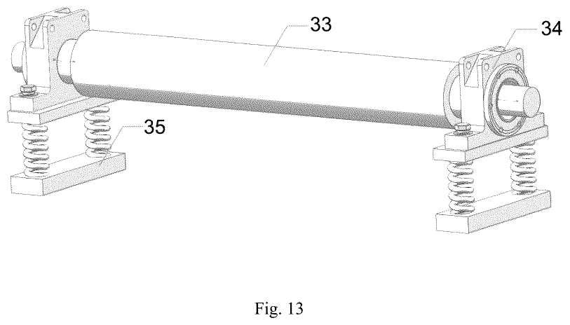

The number of the anti-slip stopping mechanism L is two; one of two anti-slip stopping mechanisms L is located on an outer side of the driving roller, and the other of the two anti-slip stopping mechanisms L is located on an outer side of the driven roller. As shown in FIG. 13, each of the two anti-slip stopping mechanisms L includes a solid cylindrical roller 33, two fifth bearings, two fifth bearing seats 34, and two spring seats 35; the two fifth bearing seats 34 are symmetrically arranged on both sides of the solid cylindrical roller 33; centers of the two fifth bearings coincide with a center of the solid cylindrical roller; the two fifth bearing seats 34 are boltedly fixed to the two spring seats 35, respectively; and the two anti-slip stopping mechanisms L of the left-rear-wheel braking-force testing unit III are structurally identical to the two anti-slip stopping mechanisms L of the right-rear-wheel braking-force testing unit IV.

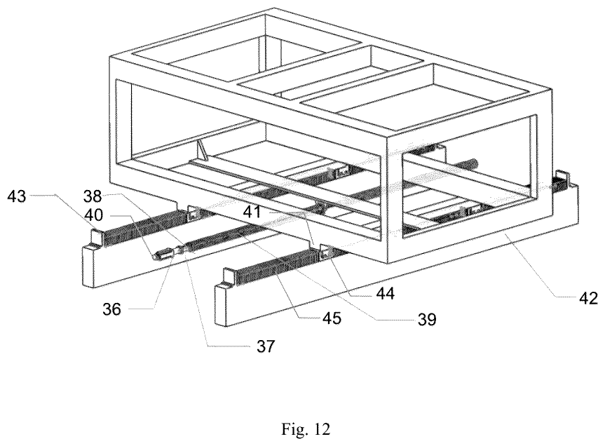

As shown in FIG. 12, the wheelbase adjustment device further includes a wheelbase adjustment motor 36, an intermediate shaft 37, a coupling 38, two dust-proof covers 39, a threaded rod 40, two supports 41 for supporting the first movable stand K, and a wheelbase adjustment rail assembly 42.

The wheelbase adjustment rail assembly 42 includes two baffle plates 43, two fasteners 44 and a sliding rail 45; the two fasteners 44 are configured to be respectively fastened to two sides of the sliding rail 45; the wheelbase adjustment motor 36 is configured to drive the first movable stand K on which the left-front-wheel braking-force testing unit I and the right-front-wheel braking-force testing unit II are provided to move along the sliding rail 45; and the two baffle plates 43 are respectively fixed at both ends of the sliding rail 45 for limiting.

Top surfaces of the two supports 41 are fixedly connected to the first movable stand K; bottom surfaces of the two supports 41 are fixedly connected to the two fasteners 44, respectively; the threaded rod is configured to pass through an assembly formed by the two fasteners and the two supports; each of the two dust-proof covers is annularly distributed along the threaded rod; the coupling 38 is fixed to an end of the threaded rod via a first screw; the intermediate shaft 37 is fixed to an end of the coupling via four second screws; and the wheelbase adjustment motor 36 is fixed to an end of the intermediate shaft 37 via a third screw.

The rotational speeds of the driving motors of the left-front-wheel braking-force testing unit I and the right-front-wheel braking-force testing unit II are corrected through the MPC control system, using the wheel speed collected by speed sensors installed at the electric vehicle's wheels as the reference speed, to achieve synchronized rotational speeds.

The testing method using the anti-force brake testing platform includes the following steps.

Parameters of the electric vehicle are input to the control cabinet system, wherein the parameters include a wheelbase of the electric vehicle; a wheelbase of an anti-force brake testing platform is adjusted by the wheelbase adjustment device based on the wheelbase of the electric vehicle; the second roller group is locked by the locking mechanism; the anti-force brake testing platform is lowered and the electric vehicle is driven to the anti-force brake testing platform; after sensing that the electric vehicle reaches the anti-force brake testing platform, a signal is sent by a sensor to make the locking mechanism disengaged from the second roller group to allow the first rear wheel and the second rear wheel to be respectively suspended between a driving roller and a driven roller of the second roller group.

According to required testing conditions, an output speed and an output torque of a driving motor of each of the first driving device and the second driving device is controlled; speed reduction and torque increase are performed by a decelerator of each of the first driving device and the second driving device; a driving roller of the first roller group is driven by a first transmission mechanism to rotate, so as to drive a driven roller of the first roller group to rotate synchronously through a first synchronous mechanism; the driving roller of the second roller group is driven by a second transmission mechanism to rotate, so as to drive the driven roller of the second roller group to rotate synchronously through a second synchronous mechanism; the first front wheel and the second front wheel are driven by the driven roller of the first roller group to rotate; and the first rear wheel and the second rear wheel are driven by the driven roller of the second roller group to rotate; a brake pedal is pressed, and a braking force of each of the first front wheel, the second front wheel, the first rear wheel and the second rear wheel is measured by a force sensor; a braking force distribution between a front axle and a rear axle of the electric vehicle and a braking synchronization between the front axle and the rear axle are determined to reflect stability of the electric vehicle during a braking process; and information from a battery management system (BMS) of the electric vehicle is read to calculate a regenerative braking energy of the electric vehicle.

After test, the second roller group are locked by the locking mechanism; and the electric vehicle is transferred from the anti-force brake testing platform.

In an embodiment of the present disclosure, the MPC control algorithm adopts finite set to control current. By combining eight basic voltage vectors in the complex plane, a combination of basic voltage vectors is selected to make the predicted values of the q-axis current and d-axis current infinitely close to the reference current value.

The three-phase voltage in the stationary coordinate system is transformed into the voltage in the dq rotating coordinate system as shown below:

$$\{ \begin{matrix}{V}_{dq} = {T}_{3 s / 2 r} \cdot {V}_{a b c} \\ {V}_{dq} = {[ {V}_{d} {V}_{q} {V}_{0} ]}^{T} \\ {V}_{abc} = {[ {V}_{a} {V}_{b} {V}_{c} ]}^{T} \\ {T}_{3 s / 2 r} = \frac{2}{3} [ \begin{matrix}cos θ & cos ( θ - 2 π / 3 ) & cos ( θ - 2 π / 3 ) \\ - sin θ & sin ( θ - 2 π / 3 ) & - sin ( θ - 2 π / 3 ) \\ 1 / 2 & 1 / 2 & 1 / 2\end{matrix} ]\end{matrix}$$

In the above formula, V_{dq} represents the voltage matrix in the dq rotating coordinate system; V_{abc} represents the voltage matrix in the three-phase stationary coordinate system; and T_{3s/2r} is the transformation matrix.

The d-axis current at the moment k is defined as i_{d(k)} and the q-axis current at moment k is defined as i_{q(k)}. The d-axis current at the moment k+1 is defined as i_{d(k+1)} and the q-axis current at the moment k+1 is defined as i_{q(k+1)} as the following formula.

$$\{ \begin{matrix}{i}_{d ( k + 1 )} = {i}_{d ( k )} + \frac{1}{{L}_{d}} ( {V}_{d} - R \times {i}_{d} + ω \times {L}_{q} \times {i}_{q} ) \times {T}_{s} \\ {i}_{q ( k + 1 )} = {i}_{q ( k )} + \frac{1}{{L}_{q}} ( {V}_{q} - R \times {i}_{q} - ω \times ( ψ + {L}_{d} \times {i}_{d} ) ) \times {T}_{s}\end{matrix}$$

In the above formula, L_{d} and L_{q} are the d-axis inductance and q-axis inductance, respectively; R is the phase resistance; φ is the flux linkage; ω is the electrical angular velocity; and Ts is the sampling period.

Since the control strategy “id=0” is adopted, the reference value of the d-axis current (i_{d}*) is always equal to 0, while the reference value of the q-axis current (i_{q}*) is obtained from the difference between the rational speed of the motor and the reference rotation speed of the motor, regulated by a PI controller.

To make the predicted d-axis current value and q-axis current value as close as possible to the reference value, a cost function is introduced as the following formula.

$$S = {( {i}_{d}^{*} - {i}_{d ( k + 1 )} )}^{2} + {( {i}_{q}^{*} - {i}_{q ( k + 1 )} )}^{2}$$

Using an online exhaustive search method, one of the eight switch combinations is selected such that the cost function S is minimized, thereby outputting a PWM wave to control the voltage of the inverter circuit, which in turn controls the motor operation.

The simulation process is as follows.

The driving motor 1 and the driving motor 2 are surface-mounted permanent magnet synchronous motors, belonging to non-salient pole motors. The direct-axis inductance (L_{d}) is equal to the quadrature-axis inductance (L_{q}), meaning that the reluctance torque generated by the direct-axis current (id) is 0, and the reluctance torque does not perform any work. Therefore, in this case, the direct-axis current does not play any role. To maximize torque output, improve current utilization, and increase system efficiency, the MPC control strategy with id=0 is selected.

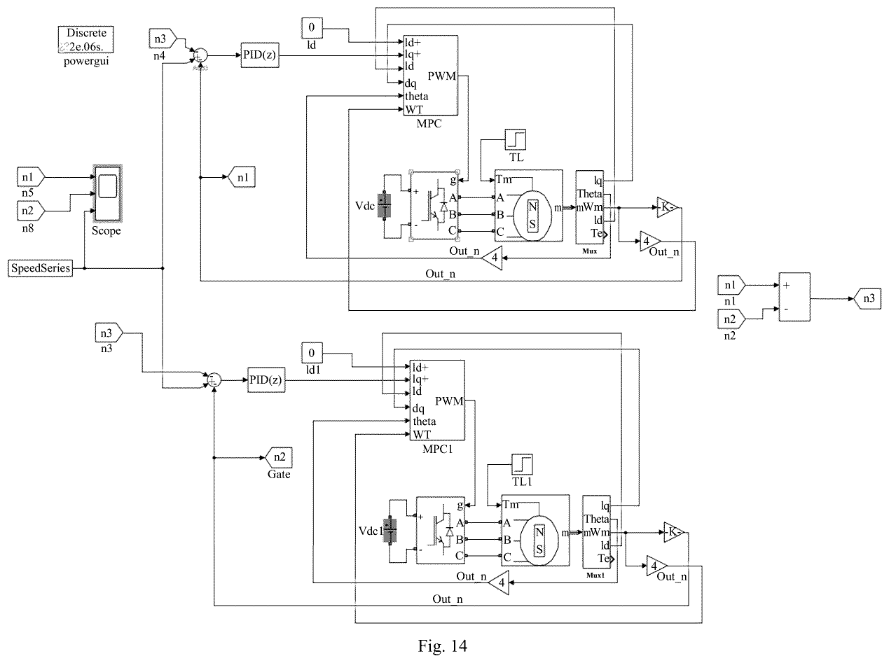

As shown in FIG. 14, in the simulation, a DC power supply is selected as the DC voltage. The inverter outputs three-phase voltage to drive the motor, where the PWM wave required by the inverter is directly provided by the MPC module. The motor's direct-axis current (id), quadrature-axis current (iq), motor angle (θ), and angular velocity (ω) are fed back to the MPC control module to adjust the PWM output. The reference current for the direct-axis is defined as i_{d}*, the reference current for the quadrature-axis is defined as i_{q}*·i_{d}*=0. The quadrature-axis reference current is obtained from the PID regulator of the speed loop.

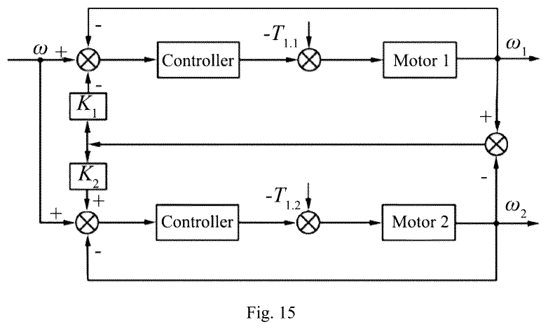

The synchronous control is achieved by a cross-coupling control strategy. A given reference speed is set for the motor to follow, and the speed synchronization error is fed forward into the speed control loop as a disturbance to minimize the speed synchronization error as much as possible. A speed coupling controller is added to transmit the speed difference between the driving motor 1 and the driving motor 2 to the motor controllers of the driving motor 1 and the driving motor 2. Under the corresponding control strategy, the driving and driven motors adjust their speeds to ensure speed synchronization of the dual motors. The block diagram of cross-coupling control is shown in FIG. 15.

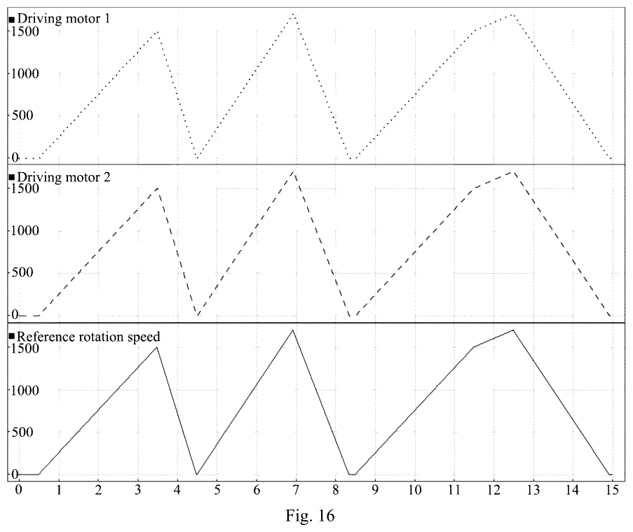

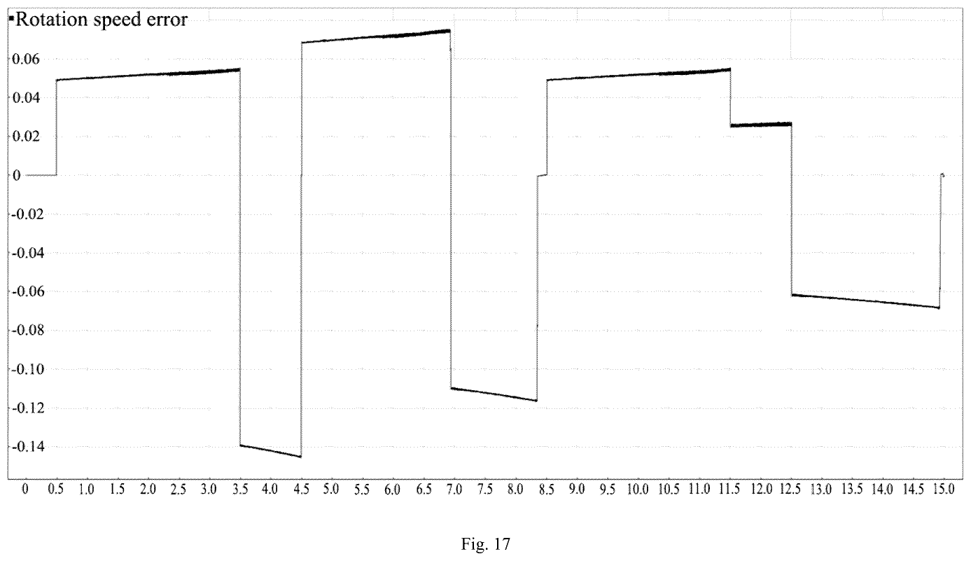

The rotation speed condition is a combination of continuous acceleration-deceleration and continuous acceleration. The simulation results are shown in FIG. 16, and the speed error results are shown in FIG. 17, where the speed error is controlled within 0.0104%.

The brake testing platform provided in this present disclosure is able to test the braking force of each wheel, measure the braking force distribution between the front and rear axles, and the braking synchronization of the front and rear axles, thus reflecting the vehicle's driving stability during the braking process. The brake testing platform provided in this present disclosure allows for the adjustment of both the front and rear axle distances, as well as the left and right wheel track distances, enabling testing of various types of vehicles. This broadens the range of test subjects and enhances applicability. The anti-slip stopping mechanism improves experimental safety. Additionally, the testing method using the anti-force brake testing platform, based on the MPC control strategy, effectively addresses the issue of electric vehicles easily detaching from the test dynamometer during the testing process.

It should be noted that the disclosed embodiments are merely exemplary, and are not limited to limit the present disclosure. It should be understood, for those skilled in the art, that those changes, modifications and replacements made without departing from the spirit of the disclosure shall fall within the scope of the disclosure defined by the appended claims.

What is claimed is:

1. An anti-force brake testing platform for an electric vehicle based on model predictive control (MPC), comprising
a first testing unit;
a second testing unit;
a third testing unit;
a fourth testing unit;
a wheelbase adjustment device; and
a control cabinet system;
wherein the first testing unit is configured to test a braking force of a first front wheel of the electric vehicle; the second testing unit is configured to test a braking force of a second front wheel of the electric vehicle; the third testing unit is configured to test a braking force of a first rear wheel of the electric vehicle; and the fourth testing unit is configured to test a braking force of a second rear wheel of the electric vehicle;
the first testing unit and the second testing unit are structurally identical and have the same height, and are provided at the same horizontal foundation plane; and each of the first testing unit and the second testing unit comprises a first driving device, a first roller group, a first lifting device, a steering device, a frame and a first control and test device;
the third testing unit and the fourth testing unit are structurally identical; each of the third testing unit and the fourth testing unit comprises a second driving device, a second roller group, a second lifting device, an anti-slip stopping mechanism, a first fixed base frame, a locking mechanism and a second control and test device; the wheelbase adjustment device comprises a second fixed base frame and a first movable stand provided on the second fixed base frame; and the third testing unit and the fourth testing unit are provided on the second fixed base frame;
the first driving device is configured to provide a first driving force, and the second driving device is configured to provide a second driving force; the first roller group is configured to transmit the first driving force to a corresponding front wheel; the second roller group is configured to transmit the second driving force to a corresponding rear wheel; the first lifting device is configured to adjust a height of the first roller group; the second lifting device is configured to adjust a height of the second roller group; and the first control and test device and the second control and test device are connected to the control cabinet system;
the locking mechanism is configured to lock the second roller group; the anti-slip stopping mechanism is configured to stop and limit a corresponding rear wheel from an outside of the second roller group; and
a centerline of the first roller group of the first testing unit coincides with a centerline of the first roller group of the second testing unit; a centerline of the second roller group of the third testing unit coincides with a centerline of the second roller group of the fourth testing unit; a centerline between the first testing unit and the second testing unit coincides with a centerline between the third testing unit and the fourth testing unit; and a centerline of the wheelbase adjustment device and the centerline between the third testing unit and the fourth testing unit are located on the same plane.

2. The anti-force brake testing platform of claim 1, wherein the first driving device comprises a driving motor, a decelerator and a transmission system; the first roller group comprises a driving roller and a driven roller; the driving motor is configured to output a power to the decelerator; the transmission system is configured to transmit the power from the decelerator to the driving roller; the driving roller is configured to transmit the power to the driven roller through a synchronous belt, so as to maintain consistent motion between the driving roller and the driven roller; and the driving motor is fixed to the first fixed base frame;
a first end of the driving roller is configured to be supported on the frame through a first rolling bearing and a first bearing seat; a second end of the driving roller is configured to be supported on the frame through a second rolling bearing and a second bearing seat; a first end of the driven roller is configured to be supported on the frame through a third rolling bearing and a third bearing seat; a second end of the driven roller is configured to be supported on the frame through a fourth rolling bearing and a fourth bearing seat; and an axis of the driving roller is parallel to an axis of the driven roller;
the driving roller is provided with a first shaft, and the first shaft is provided on the first bearing seat and the second bearing seat through the first rolling bearing and the second rolling bearing; the first shaft is configured to align with a center of the first rolling bearing and a center of the second rolling bearing; a surface side of each of the first rolling bearing and the second rolling bearing is parallel to an end face of the first shaft; the first rolling bearing and the second rolling bearing are symmetrically arranged; two sides of the driving roller are each provided with a second shaft; the second shaft at one side of the driving roller is connected to a transmission gear of the transmission system through a first pin key; and the second shaft at the other side of the driving roller is connected to the synchronous belt via a second pin key; and
the driven roller is provided with a third shaft, and the third shaft is provided on the third bearing seat and the fourth bearing seat through the third rolling bearing and the fourth rolling bearing; the third shaft is configured to align with a center of the third rolling bearing and a center of the fourth rolling bearing; a side surface of each of the third rolling bearing and the fourth rolling bearing is parallel to an end face of the third shaft; the third rolling bearing and the fourth rolling bearing are symmetrically arranged; two sides of the driven roller are each provided with a fourth shaft; the fourth shaft at one side of the driven roller is configured to be vacant; the fourth shaft at the other side of the driven roller is connected to the synchronous belt via a third pin key.

3. The anti-force brake testing platform of claim 2, wherein the first lifting device comprises a lifting block and an air pump; a transverse centerline of the first lifting device is provided at a center between the driving roller and the driven roller; a front surface of the lifting block is parallel to a vertical section of the driving roller; a rear surface of the lifting block is parallel to a vertical section of the driven roller; a lower end of the lifting block is connected to the air pump via three linkage mechanisms, thereby transmitting a force from the air pump to the lifting block; the air pump is fixed to an air pump support frame; the air pump support frame is secured to the frame through four bolts; and the four bolts are symmetrically arranged.

4. The anti-force brake testing platform of claim 3, wherein the steering device comprises a first steering gear, a second steering gear, and a steering servo motor; the first steering gear is larger than the second steering gear; the frame is provided above the first steering gear and the second steering gear; the first steering gear is engaged with the second steering gear on the same plane; and the first steering gear is connected to a transmission shaft and the steering servo motor via a fourth pin key;
the anti-force brake testing platform further comprises a track width adjustment device; the track width adjustment device comprises a second movable stand; the frame, the first steering gear and the second steering gear are provided on the second movable stand; the track width adjustment device further comprises two first adjustment rails and two second adjustment rails; and the two first adjustment rails are perpendicular to the two second adjustment rails;
each of the two first adjustment rails comprises two first rail assemblies; the two first rail assemblies are structurally identical, and are symmetrically arranged; each of the two first adjustment rails is covered by a first compressible dust-proof cover; and an end of each of the two first adjustment rails is provided with a first baffle; and
each of the two second adjustment rails comprises two second rail assemblies; the two second rail assemblies are structurally identical, and are symmetrically arranged; each of the two second adjustment rails is covered by a second compressible dust-proof cover; and an end of each of the second adjustment rails is provided with a second baffle.

5. The anti-force brake testing platform of claim 1, wherein the second driving device comprises a driving motor, a decelerator and a transmission system; the second roller group comprises a driving roller and a driven roller; the driving motor is configured to output a power to the decelerator; the transmission system is configured to transmit the power from the decelerator to the driving roller; the driving roller is configured to transmit the power to the driven roller through a synchronous belt, so as to maintain consistent motion between the driving roller and the driven roller; and the driving motor is fixed to a middle subframe of the first movable stand;
the driving roller and the driven roller are structurally identical; a first end of the driving roller is configured to be supported on the first fixed base frame through a first rolling bearing and a first bearing seat; a second end of the driving roller is configured to be supported on the first fixed base frame through a second rolling bearing and a second bearing seat; a first end of the driven roller is configured to be supported on the first fixed base frame through a third rolling bearing and a third bearing seat; a second end of the driven roller is configured to be supported on the first fixed base frame through a fourth rolling bearing and a fourth bearing seat; and an axis of the driving roller is parallel to an axis of the driven roller;
the driving roller is provided with a first shaft, and the first shaft is provided on the first bearing seat and the second bearing seat through the first rolling bearing and the second rolling bearing; the first shaft is configured to align with a center of the first rolling bearing and a center of the second rolling bearing; a side surface of each of the first rolling bearing and the second rolling bearing is parallel to an end face of the first shaft; the first rolling bearing and the second rolling bearing are symmetrically arranged; two sides of the driving roller are each provided with a second shaft; the second shaft at one side of the driving roller is connected to a transmission gear of the transmission system through a first pin key, and the second shaft at the other side of the driving roller is connected to the synchronous belt via a second pin key; and
the driven roller is provided with a third shaft, and the third shaft is provided on the third bearing seat and the fourth bearing seat through the third rolling bearing and the fourth rolling bearing; the third shaft is configured to align with a center of the third rolling bearing and a center of the fourth rolling bearing; a side surface of each of the third rolling bearing and the fourth rolling bearing is parallel to an end face of the third shaft; the third rolling bearing and the fourth rolling bearing are symmetrically arranged; two sides of the driven roller are each provided with a fourth shaft; the fourth shaft at one side of the driven roller is configured to be vacant, and the fourth shaft at the other side of the driven roller is connected to the synchronous belt via a third pin key.

6. The anti-force brake testing platform of claim 5, wherein the second lifting device comprises a lifting block and an air pump; a transverse centerline of the second lifting device is provided at a center between the driving roller and the driven roller; a front surface of the lifting block is parallel to a vertical section of the driving roller; a rear surface of the lifting block is parallel to a vertical section of the driven roller; a lower end of the lifting block is connected to the air pump via a first linkage, thereby transmitting a force from the air pump to the lifting block; the air pump is fixed to an air pump support frame; the air pump support frame is secured to the first movable stand through four first bolts; and the four first bolts are symmetrically arranged.

7. The anti-force brake testing platform of claim 6, wherein the number of the locking mechanism is two; two locking mechanisms are connected to the lifting block through a second linkage and a second bolt;
the two locking mechanisms are symmetrically arranged with respect to the air pump; the two locking mechanisms are configured to rise to lock the second roller group in response to a case that the lifting block is driven by the air pump to rise; and
the number of the anti-slip stopping mechanism is two; one of two anti-slip stopping mechanisms is located on an outer side of the driving roller, and the other of the two anti-slip stopping mechanisms is located on an outer side of the driven roller; each of the two anti-slip stopping mechanisms comprises a solid cylindrical roller, two fifth bearings, two fifth bearing seats, and two spring seats; the two fifth bearing seats are symmetrically arranged on both sides of the solid cylindrical roller; centers of the two fifth bearings coincide with a center of the solid cylindrical roller; the two fifth bearing seats are boltedly fixed to the two spring seats, respectively; and the two anti-slip stopping mechanisms of the third testing unit are structurally identical to the two anti-slip stopping mechanisms of the fourth testing unit.

8. The anti-force brake testing platform of claim 1, wherein the wheelbase adjustment device further comprises a wheelbase adjustment motor, an intermediate shaft, a coupling, two dust-proof covers, a threaded rod, two supports for supporting the first movable stand, and a wheelbase adjustment rail assembly; the wheelbase adjustment rail assembly comprises two baffle plates, two fasteners and a sliding rail; the two fasteners are configured to be respectively fastened to two sides of the sliding rail; the wheelbase adjustment motor is configured to drive the first movable stand on which the first testing unit and the second testing unit are provided to move along the sliding rail; and the two baffle plates are respectively fixed at both ends of the sliding rail for limiting; and
top surfaces of the two supports are fixedly connected to the first movable stand; bottom surfaces of the two supports are fixedly connected to the two fasteners, respectively; the threaded rod is configured to pass through an assembly formed by the two fasteners and the two supports; each of the two dust-proof covers is annularly distributed along the threaded rod; the coupling is fixed to an end of the threaded rod via a first screw; the intermediate shaft is fixed to an end of the coupling via four second screws; and the wheelbase adjustment motor is fixed to an end of the intermediate shaft via a third screw.

9. The anti-force brake testing platform of claim 2, wherein the anti-force brake testing platform further comprises a MPC system; each of the first front wheel and the second front wheel is provided with a speed sensor to collect a wheel rotation speed; and the MPC system is configured to correct a rotation speed of the driving motor to be the same as the wheel rotation speed, so as to achieve synchronized rotation.

10. A testing method using the anti-force brake testing platform of claim 1, comprising:
inputting parameters of the electric vehicle to the control cabinet system, wherein the parameters comprise a wheelbase of the electric vehicle; adjusting, by the wheelbase adjustment device, a wheelbase of the anti-force brake testing platform based on the wheelbase of the electric vehicle; locking, by the locking mechanism, the second roller group; lowering the anti-slip stopping mechanism and driving the electric vehicle to the anti-force brake testing platform; after sensing that the electric vehicle reaches the anti-force brake testing platform, sending, by a sensor, a signal to make the locking mechanism disengaged from the second roller group to allow the first rear wheel and the second rear wheel to be respectively suspended between a driving roller and a driven roller of the second roller group;
according to required testing conditions, controlling an output speed and an output torque of a driving motor of each of the first driving device and the second driving device; performing, by a decelerator of each of the first driving device and the second driving device, speed reduction and torque increase; driving, by a first transmission mechanism, a driving roller of the first roller group to rotate, so as to drive a driven roller of the first roller group to rotate synchronously through a first synchronous mechanism; driving, by a second transmission mechanism, the driving roller of the second roller group to rotate, so as to drive the driven roller of the second roller group to rotate synchronously through a second synchronous mechanism; driving, by the driven roller of the first roller group, the first front wheel and the second front wheel to rotate; and driving, by the driven roller of the second roller group, the first rear wheel and the second rear wheel to rotate; pressing a brake pedal, and measuring, by a force sensor, a braking force of each of the first front wheel, the second front wheel, the first rear wheel and the second rear wheel; determining a braking force distribution between a front axle and a rear axle of the electric vehicle and a braking synchronization between the front axle and the rear axle to reflect stability of the electric vehicle during a braking process; and reading information from a battery management system (BMS) of the electric vehicle to calculate a regenerative braking energy of the electric vehicle; and
after test, locking, by the locking mechanism, the second roller group; and transferring the electric vehicle form the anti-force brake testing platform.
